(19) United States
(12) Patent Application Publication
(10) Pub. No.: US 2021/0090148 A1
(43) Pub. Date: Mar. 25, 2021

(54) NOTIFICATION SYSTEM AND NOTIFICATION PROGRAM

(71) Applicant: TOSHIBA TEC KABUSHIKI KAISHA, Tokyo (JP)

(72) Inventor: Yukiko YOKOYAMA, Sunto Shizuoka (JP)

(73) Assignee: TOSHIBA TEC KABUSHIKI KAISHA, Tokyo (JP)

(21) Appl. No.: 16/905,746

(22) Filed: Jun. 18, 2020

(30) Foreign Application Priority Data
Sep. 20, 2019 (JP) 2019-171503

(51) Int. Cl. G06Q 30/06

(52) U.S. Cl. CPC G06Q 30/0613

(57) ABSTRACT

A notification system includes a customer-state discriminating unit and a first transmitting unit of at least one computer. The customer-state discriminating unit discriminates a state of a customer in a store. When a specific state by the customer is discriminated, the first transmitting unit transmits first information corresponding to the specific state to a plurality of electronic devices respectively carried by store clerks in the store.

### CROSS-REFERENCE TO RELATED APPLICATION

This application is based upon and claims the benefit of priority from Japanese Patent Application No. 2019-171503, filed in Sep. 20, 2019, the entire contents of which are incorporated herein by reference.

### FIELD

Embodiments described herein relate generally to a notification system and a notification program to be executed by a computer.

### BACKGROUND

Ina store such as a volume retailer, if a shopper searches for a commodity that the shopper desires, in some cases, the shopper moves around shelves related to the commodity to search for the commodity and, in other cases, the shopper cannot find the commodity and gives up purchasing the commodity, although the commodity is present. A child sometimes strays from a guardian and wanders in the store searching for the guardian.

On the other hand, since a store clerk carries out a job that the store clerk is in charge of, the store clerk cannot always attend customers and cannot realize whether other store clerks can attend customers. Therefore, even if there is a customer who needs help such as a customer who is searching for a commodity or a customer who is likely to be a stray child, the store clerks cannot appropriately attend the customer in cooperation.

Related art is described in, for example, JP-A-2018-132803.

### DESCRIPTION OF THE DRAWINGS

FIG. 1 is a block diagram illustrating the arrangement of a notification system in at least one embodiment;

FIG. 2 is a block diagram illustrating a main part circuit configuration of a server in at least one embodiment;

FIG. 3 is a diagram illustrating a data arrangement information of a data table in at least one embodiment;

FIG. 4 is a diagram illustrating a data arrangement example of a customer management table in at least one embodiment;

FIG. 5 is a diagram illustrating a data arrangement example of an attribute table in at least one embodiment;

FIG. 6 is a diagram illustrating an example of information transmitted to an electronic device in at least one embodiment;

FIG. 7 is a flowchart illustrating processing executed by a processor of the server;

FIG. 8 is a diagram illustrating an example of a region equivalent to a person detected from an image in at least one embodiment; and

FIGS. 9A to 9D are diagrams illustrating screen examples displayed on the electronic device.

### DETAILED DESCRIPTION

An object of at least one embodiment is to provide a notification system and a notification program for enabling store clerks to share information to be able to appropriately attend a customer who needs help.

According to at least one embodiment, a notification system includes a customer-state discriminating unit and a first transmitting unit of at least one computer. The customer-state discriminating unit discriminates a state of a customer in a store. When a specific state by the customer is discriminated, the first transmitting unit transmits first information corresponding to the specific state to a plurality of electronic devices respectively carried by store clerks in the store.

At least one embodiment is explained below with reference to the drawings.

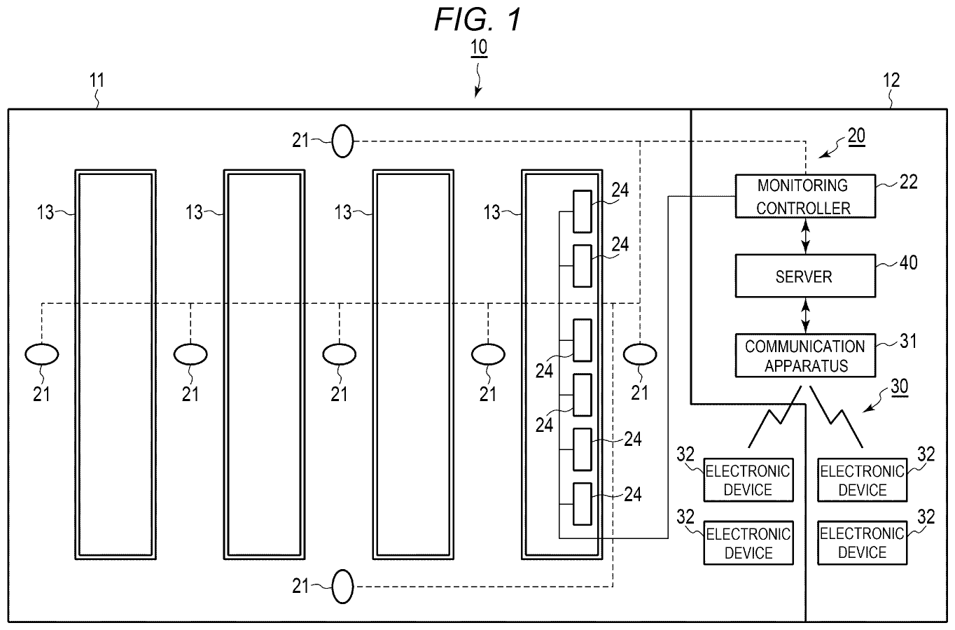

FIG. 1 is a block diagram illustrating an arrangement of a notification system in at least one embodiment. The notification system in this embodiment is set in a store 10 such as a volume retailer, a large electrical appliance store, or a do-it-yourself store. The notification system has a function for discriminating states of customers present in a store and giving a notification to electronic devices 32 carried by store clerks such that the store clerks can share information for attending customers according to the states of the customers.

As illustrated in FIG. 1, the store 10 includes a sales floor (e.g., a selling floor) 11 and a back office 12 other than the sales floor 11. A plurality of commodity shelves 13 are disposed in the sales floor 11. Spaces among the commodity shelves 13 and spaces between the commodity shelves 13 and walls are passages for customers. A customer visiting the store moves around the passages in the sales floor 11, takes, from the commodity shelves 13, commodities that the customer desires to purchase, and puts the commodities in a shopping cart or the like. The customer finishing shopping performs checkout in a checkout place provided in a part of the sales floor 11.

In the store 10, a monitoring system. 20, a communication system 30, and a server 40 functioning as an information processing device are provided in order to enable the store clerks to appropriately attend customers present in the sales floor 11.

In order to discriminate among states (actions) of customers present in the store 10, the monitoring system 20 includes, for example, a plurality of cameras 21, a plurality of sensors 24, and a monitoring controller 22 that controls the cameras 21 and the sensors 24.

The cameras 21 are set for each of the passages to be able to cover an entire passage region of the sales floor 11 as a photographing region. The number and attachment places of the cameras 21 are not particularly limited. In short, the entire passage region only has to be set as the photographing region such that states of customers present in the passages can be photographed. In at least one embodiment, for convenience of explanation, it is assumed that one camera 21 is set in one passage as illustrated in FIG. 1.

The plurality of sensors 24 are, for example, weight sensors provided in the commodity shelves 13. The sensors 24 are sensors for detecting weight changes of commodities placed on the commodity shelves 13. If a decrease in weight is detected by the sensors 24, it can be discriminated that a customer performs an action of taking a commodity from a shelf. In FIG. 1, the sensors 24 are illustrated only in one commodity shelf 13. However, the sensors 24 are also set in the other commodity shelves 13.

In the configuration example explained above, the cameras 21 and the sensors 24 (the weight sensors) are provided in order to acquire information for discriminating the states of the customers. However, other input devices may be used to make it possible to acquire various kinds of information. For example, infrared sensors for detecting positions of the customers, microphones for inputting voice uttered by the customers, and the like may be set to make it possible to discriminate the states of the customers based on input information.

The cameras 21 and the sensors 24 are connected to the monitoring controller 22 via wired communication or wireless communication to control the operations of the cameras 21 and the sensors 24. The monitoring controller 22 receives signals of images photographed by each of the cameras 21 and receives detection signals from the sensors 24.

The communication system 30 includes a communication apparatus 31 and a plurality of electronic devices 32. The communication apparatus 31 sets the entire region of the store 10 including the sales floor 11 and the back office 12 as a wireless communication region and enables wireless communication with the electronic devices 32 present in the wireless communication region. The electronic devices 32 are, for example, smartphones. Each of a plurality of store clerks in charge of customer attendance carries one electronic device 32. The store clerks in charge of customer attendance are present in the sales floor 11 or the back office 12 in a state in which the store clerks carry the electronic devices 32. By receiving a command from the communication apparatus 31 with the electronic devices 32, the store clerks can share, among the plurality of customers, information for customer attendance corresponding to a state of a customer who takes a specific state and can take an action for appropriate customer attendance.

Examples of the customer who takes the specific state include a customer who is searching for a commodity, a customer (a child) who is likely to be a stray child, and customers who are likely to perform abnormal actions such as violence and shoplifting. The customer who is searching for a commodity can be specified by discriminating an action of, for example, staying in the store without picking up a commodity for a fixed time or longer or an action of moving around the commodity shelves 13. The customer (the child) who is likely to be a stray child can be specified by discriminating an action of a child, who acts together with an adult, separating from the adult and staying in the same place for a fixed time or longer or moving around among the commodity shelves 13. The customers who are likely to perform abnormal actions such as violence and shoplifting can be specified by discriminating movements characteristic to the respective actions.

States (actions) of customers to be attended in the communication system in this embodiment are not limited to the contents described above (the commodity search, the stray child, and the abnormal action). The notification system can deal with states (actions) of other customers who need customer attendance.

The server 40 has functions of a customer-state discriminating unit that discriminates a state of a customer in the store, a first transmitting unit that, if the specific state by the customer is discriminated, transmits first information corresponding to the specific state to a plurality of electronic devices respectively carried by the store clerks in the store, a receiving unit that receives responses from the electronic devices responding to a notification, and a second transmitting unit that transmits second information corresponding to the responses to at least one electronic device. The server 40 electrically connects the monitoring controller 22 and the communication apparatus 31 in order to realize these functions. The server 40 is implemented with a notification program explained below.

In FIG. 1, all of the monitoring controller 22, the communication apparatus 31, and the server 40 are illustrated as being provided in the back office 12. However, the monitoring controller 22, the communication apparatus 31, and the server 40 do not always have to be provided in the back office 12. For example, the monitoring controller 22 may be provided in the sales floor 11 if the monitoring controller 22 can transmit and receive signals to and from the cameras 21. The communication apparatus 31 may be provided in the sales floor 11 if the communication apparatus 31 can wirelessly communicate with the electronic devices 32 carried by the store clerks present in the store 10. The server 40 may be placed under an environment of cloud computing that provides computer resources via a network such as the Internet.

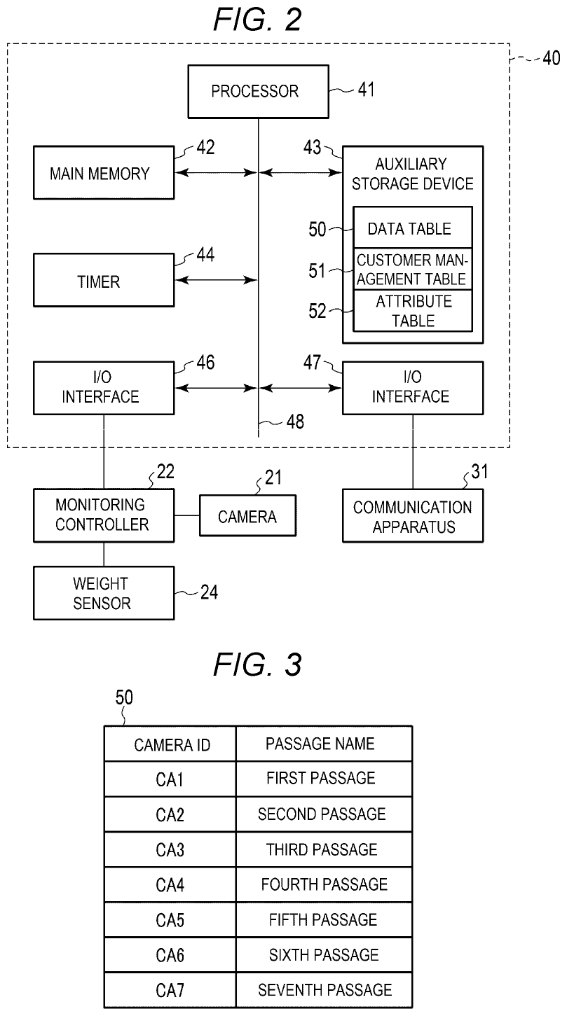

FIG. 2 is a block diagram illustrating a main part circuit configuration of the server 40 in this embodiment. The server 40 includes a processor 41, a main memory 42, an auxiliary storage device 43, a timer 44, a first I/O (Input/Output) interface 46, a second I/O interface 47, and a system transmission line 48. The system transmission line 48 includes an address bus, a data bus, and a control signal line. In the server 40, the processor 41, the main memory 42, the auxiliary storage device 43, the timer 44, and the first and second I/O interfaces 46 and 47 are connected to the system transmission line 48. In the server 40, a computer is configured by the processor 41, the main memory 42, and the auxiliary storage device 43 and the system transmission line 48 connecting the forgoing.

The processor 41 is equivalent to a central part of the computer. The processor 41 controls the units according to an operating system or application programs in order to realize the various functions of the server 40. The processor 41 is, for example, a CPU (Central Processing Unit).

The main memory 42 is equivalent to a main storage portion of the computer. The main memory 42 includes a nonvolatile memory region and a volatile memory region. The main memory 42 stores the operating system and the application programs in the nonvolatile memory region. The application programs include a notification program explained below. The main memory 42 sometimes stores, in the nonvolatile or volatile memory region, data necessary for the processor 41 to execute processing for controlling the units. The main memory 42 uses the volatile memory region as a work area in which data is rewritten as appropriate by the processor 41. The nonvolatile memory region is, for example, a ROM (Read Only Memory). The volatile memory region is, for example, a RAM (Random Access Memory).

The auxiliary storage device 43 is equivalent to an auxiliary storage portion of the computer. For example, an EEPROM (Electric Erasable Programmable Read-Only Memory), an HDD (Hard Disc Drive), or an SSD (Solid State Drive) can be the auxiliary storage device 43. The auxiliary storage device 43 saves data used by the processor 41 in performing various kinds of processing, data created by processing in the processor 41, or the like. The auxiliary storage device 43 sometimes stores the application programs including the notification program explained below.

The timer 44 performs a time measuring operation according to a command from the processor 41.

The first I/O interface 46 performs transmission and reception of data signals to and from the monitoring controller 22. The second I/O interface 47 performs transmission and reception of data signals to and from the communication apparatus 31.

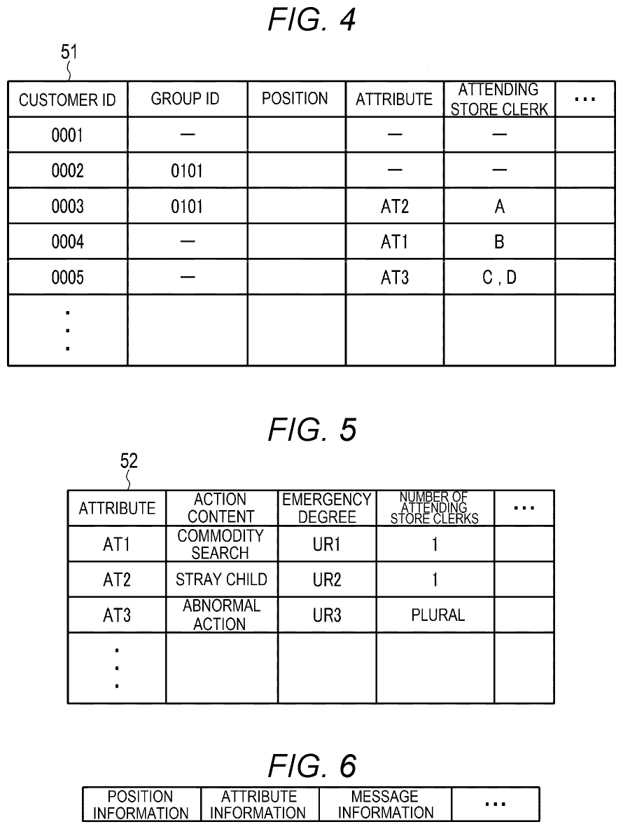

The server 40 stores, in the main memory 42 or the auxiliary storage device 43, a data table 50 having a data structure illustrated in FIG. 3, a customer management table 51 illustrated in FIG. 4, and an attribute table 52 illustrated in FIG. 5.

As illustrated in FIG. 3, the data table 50 correlates passage names respectively with a plurality of camera IDs and records the passage names.

The camera IDs are unique codes individually allocated to the cameras 21 disposed in the sales floor 11. The camera IDs set for the cameras 21 are given to image data photographed by each of the cameras 21 and transmitted to the monitoring controller 22.

The passage names are peculiar names set for the passages in the photographing region covered by the cameras 21 specified by the camera ID corresponding thereto. Different passage names, for example, “first passage” and “second passage” are set for the passages in the sales floor 11. Simply by hearing a passage name, the store clerks can recognize which place in the sales floor 11 the passage is.

As illustrated in FIG. 4, the customer management table 51 correlates and records data for managing customers present in the store 10. In the customer management table 51, data such as a customer ID, a group ID, a position, an attribute, and an attending store clerk are registered.

The customer ID is a unique code allocated to a customer visiting the store 10. The group ID is a unique code allocated to a group of a plurality of people visiting the store such as a family. The position is data indicating a present position of a customer in the store 10. The attribute is a code indicating information set in the attribute table 52 corresponding to a customer who is discriminated as being in the specific state. The attending store clerk indicates, if the customer is discriminated as being in the specific state, a store clerk set in order to attend the customer.

It is assumed that information (names and the like) of the store clerks respectively carrying the plurality of electronic devices 32 used in the store 10 is also stored in the server 40.

As illustrated in FIG. 5, the attribute table 52 correlates information corresponding to the state of the customer discriminated as being the specific state with a code indicating the attribute and records the information. Information such as an attribute code, action content, an emergency degree, and the number of attending store clerks is recorded in the attribute table 52. For example, action content “commodity search”, an emergency degree UR1, and the number of attending store clerks “1” are recorded in an attribute codeAT1. That is, fora customer discriminated as performing a commodity search, a lowest emergency degree (a larger number indicates a higher emergency degree) and customer attendance by one store clerk are set. For example, the emergency degree UR1 indicates that customer attendance is carried out if a store clerk capable of attending the customer is present. Emergency degrees UR2 and UR3 indicate that customer attendance is carried out more preferentially than a normal job. For a customer discriminated as performing action content “abnormal action”, attendance by a plurality of store clerks is set.

FIG. 6 illustrates an example of information transmitted to the electronic devices 32 carried by the store clerks if the customer is discriminated as being in the specific state.

As illustrated in FIG. 6, if discriminating that the customer in the specific state is present, the server 40 transmits, for example, information (the first information) including position information indicating the present position of the customer and information (an attribute code) corresponding to the state of the customer. A store clerk who acquires this information can share, with the other store clerks, the place where the customer in the specific state is present. The server 40 sets, according to a response about present states of the store clerks, which store clerk attends the customer and transmits information (the second information) to which message information (indicating an emergency degree, the number of attending store clerks, an attending store clerk, and the like) for performing attendance corresponding the specific state of the customer (a commodity search, a stray child, an abnormal action, and the like) is further added.

The operation by the server 40 in this embodiment is explained.

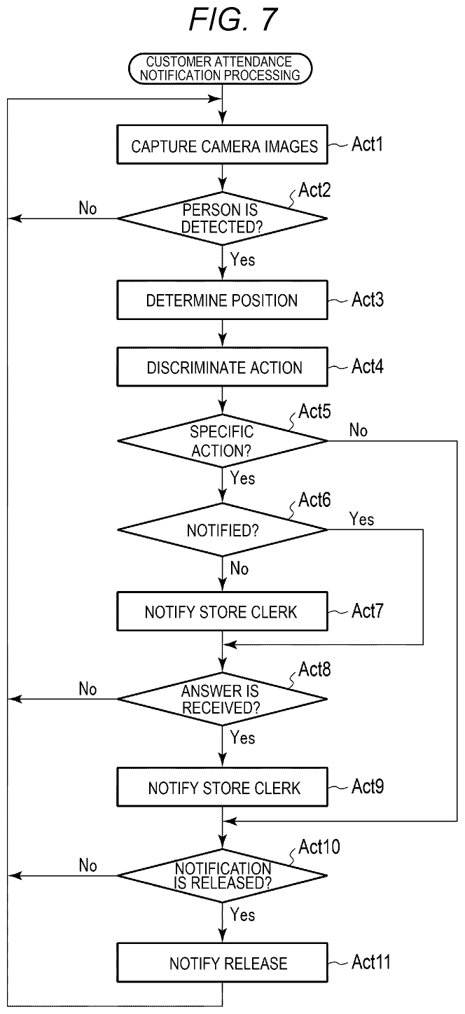

FIG. 7 is a flowchart illustrating a procedure of main processing executed by the processor 41 of the server 40 according to a notification program. Functions of the server 40 are specifically explained below with reference to FIG. 7. Content explained blow is an example. The procedure and the content are not particularly limited if the same functions can be obtained.

The processor 41 sequentially captures, in a time division manner, image data of images photographed by each of the cameras 21 from the monitoring controller 22 via the first I/O interface 46 (Act 1). The processor 41 can capture image data respectively photographed by the plurality of cameras 21 set in the store 10. The processor 41 analyzes the image data every time the image data is captured and determines whether a person is imaged. That is, the processor 41 discriminates whether a region AR equivalent to a person is detected from the images photographed by the camera 21 indicated by the image data. If a person is not imaged, the processor 41 determines NO in Act 2 and returns to Act 1. In Act 1, the processor 41 captures the next image data from the monitoring controller 22.

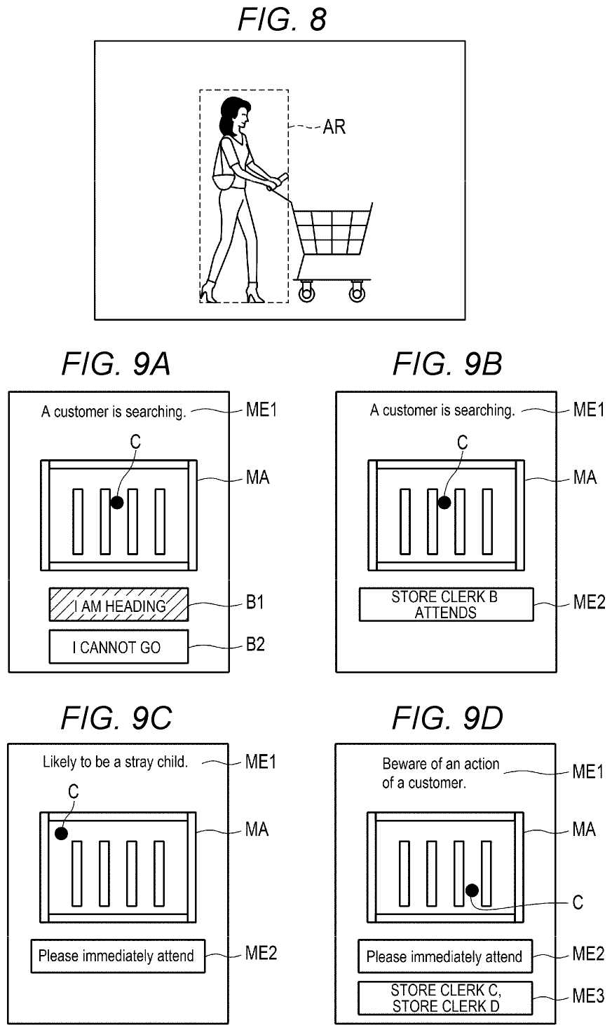

On the other hand, if a person is photographed by the camera 21 (Yes in Act 2), the processor 41 sets a customer ID corresponding to the detected person in the customer management table 51. FIG. 8 is a diagram illustrating the region AR equivalent to the person (a shopper) detected from an image based on image data.

The processor 41 determines a position in the store 10 of the photographed person based on setting of the camera 21 that photographs the image data in which the region AR is detected, a position where the region AR is detected in the image, and the like (Act 3). The processor 41 correlates data indicating a present position with a customer ID corresponding to the person and records the data in the customer management table 51.

If a plurality of people are continuously detected in near positions, the processor 41 discriminates that the plurality of people are a group of a plurality of shopping people such as a family. In this case, the processor 41 correlates the same group ID respectively with customer IDs of customers included in the same group and records the group ID in the customer management table 51 to indicate that the customers are included in the same group. For example, in the customer management table 51 illustrated in FIG. 4, the same group ID “1010” indicating the same group is correlated with customer IDs “0002” and “0003” and recorded.

Thereafter, every time image data is captured (Act 1), by continuously detecting the region AR corresponding to a person to whom a customer ID is set, the processor 41 can continue to track the position of the person moving in the store 10 (Act 2 and Act 3). The processor 41 discriminates an action of the customer based on a change of the position of the customer, a change of the region AR (that is, a motion of the customer), and the like (Act 4).

If discriminating that the action by the customer is a normal action for shopping (No in Act 5), as explained above, the processor 41 continues the tracking of the customer based on the captured image data (Act 10, No Acts 1 to 5).

On the other hand, if discriminating that the action by the customer is in the specific state (Yes in Act 5) and if information concerning the customer is not notified to the store clerks yet, that is, information concerning the customer is not transmitted to the electronic devices 32 carried by the store clerks (No in Act 6), the processor 41 transmits, through the communication apparatus 31, information (the first information) including, for example, position information indicating the present position of the customer and information (an attribute code) corresponding to the state of the customer. The processor 41 transmits, at the same time, the information to the plurality of electronic devices 32 carried by the plurality of store clerks.

In at least one embodiment, if an action of a customer explained below is discriminated, it is discriminated that the customer is in a state in which the customer needs customer attendance.

For example, if an action of staying in the store without picking up a commodity for a fixed time or longer or an action of moving around the commodity shelves 13 is discriminated, it is determined that the customer is performing a “commodity search”. If a customer to whom a group ID is given and who is estimated as a child from a size and a shape of the region AR detected from an image and an action of staying in the same place alone for a fixed time or longer or moving around among the commodity shelves 13 is discriminated, it is discriminated that the customer is a customer (a child) who is likely to be a “stray child”. If a characteristic action same as an action of a person who commits violence, shoplifting, or the like is discriminated, it is discerned that the customer is performing an “abnormal action”.

The electronic device 32 performs, according to the information received from the communication apparatus 31, an output for presenting, to the store clerks, information for attendance corresponding to the state of the customer. FIG. 9A illustrates a display example on a touch panel in the electronic device 32. The example illustrated in FIG. 9A is an example in which an attribute code corresponding to the “commodity search” is received as attribute information together with position information indicating the present position of the customer.

The electronic device 32 causes the touch panel to display a store map MA and display a customer mark C indicating the position of the customer based on the position information. The electronic device 32 causes, according to the attribute code, the touch panel to display a message ME1 for notifying the state of the customer to the store clerk. In this case, the message ME1 “a customer is searching for a commodity” for notifying that the customer is performing the “commodity search” is displayed.

In the case of the attribute code AT1, an “I am heading” button B1 for answering that the store clerk is capable of performing customer attendance and an “I cannot go” button B2 for answering that the store clerk is not capable of performing customer attendance are displayed on the electronic device 32.

In this way, the information corresponding to the state of the customer can be transmitted at the same time from the communication apparatus 31 to the electronic devices 32 carried by the plurality of store clerks. Consequently, the plurality of store clerks can share the information for customer attendance corresponding to the state of the customer.

For example, if operation for selecting the “I am heading” button B1 is performed by operation of the store clerk, the electronic device 32 transmits response data corresponding to the operation to the communication apparatus 31. After notifying the information to the electronic device 32 (Yes in Act 6), if receiving the response data through the communication apparatus 31 (Yes in Act 8), the processor 41 of the server 40 generates information corresponding to the response and transmits information (the second information) for customer attendance corresponding to the state of the customer to at least one electronic device 32.

That is, the processor 41 sets, according to the response concerning the present states of the store clerks, which store clerk performs customer attendance and transmits information (the second information) to which message information (indicating an emergency degree, the number of attending store clerks, an attending store clerk, and the like) for coping with the specific state of the customer (a commodity search, a stray child, an abnormal action, or the like) is further added.

For example, if the customer is in the state of the “commodity search”, since the number of attending store clerks is correlated with the attribute code AT1 (“commodity search”) and set to “1” in the attribute table 52, the processor 41 selects one store clerk as a store clerk in charge of customer attendance out of the store clerks who answer that the store clerks are capable of performing customer attendance. The processor 41 creates message information for notifying, to the plurality of store clerks who share the information, that the store clerk selected as the store clerk in charge of customer attendance performs customer attendance and transmits the message information to the electronic devices 32.

FIG. 9B illustrates a display example on the touch panel in the electronic device 32 that receives the second information. In the example illustrated in FIG. 9B, a message ME2 “a store clerk B attends” for notifying that the store clerk B performs customer attendance is displayed.

In this way, by confirming, through the electronic devices 32, the information received from the communication apparatus 31, the plurality of store clerks can share information indicating that the “store clerk B” attends the customer in the state of the “commodity search”. Therefore, the store clerks other than the “store clerk B” can continue jobs in operation. On the other hand, the “store clerk B” is capable of performing appropriate attendance leading to commodity sales by moving to a place indicated by the customer mark C displayed on the store map MA, for example, helping the customer, and informing the customer about a commodity and a selling location (e.g., a portion of the sales floor).

Concerning the action content “commodity search” with the emergency degree “UR1”, customer attendance is unnecessary if a store clerk capable of performing customer attendance is absent. On the other hand, in the case of the emergency degrees UR2 and UR3, customer attendance is carried out more preferentially than the normal job.

For example, if a customer (a child) who is likely to be a “stray child” is present, the processor 41 transmits information to the electronic device 32 to cause the electronic device 32 to display a screen illustrated in FIG. 9C. That is, the processor 41 causes the electronic device 32 to display the message ME1 “Likely to be a stray child” for notifying that the customer (the child) who is likely to be a “stray child” is present and the store map MA (the customer mark C) and causes the electronic device 32 to display the message ME2 “Please immediately attend” for notifying implementation of customer attendance. The processor 41 selects a store clerk who performs customer attendance (for example, a person in charge of a sales floor where the target customer is present), transmits the information to the electronic device 32 carried by the store clerk, and causes the electronic device 32 to display the screen illustrated in FIG. 9C. The store clerk who receives this notification is capable of immediately attend the customer (the child) who is likely to be a “stray child”. In this case as well, as explained above, the processor 41 is also capable of receiving answers about whether the store clerks can perform customer attendance, selecting a store clerk in charge of customer attendance, and transmitting information.

If a customer discriminated as performing the action content “abnormal action” is present, the number of attending store clerks is correlated with an attribute code AT3 (“abnormal action”) and set to “plural” in the attribute table 52. Therefore, the processor 41 selects a plurality of (for example, two) store clerks as store clerks in charge of customer attendance from the store clerks who answer that the store clerks are capable of performing customer attendance. The processor 41 creates message information for notifying the plurality of store clerks, who share the information, that the store clerk selected as the store clerk in charge of customer attendance performs customer attendance and transmits the message information to the electronic devices 32. For example, as illustrated in FIG. 9D, a message ME3 “a store clerk C, a store clerk D” for notifying that the store clerks C and D perform customer attendance is added.

The “store clerk C” and the “store clerk D” sharing the information in this way are capable of attending the target customer (for example, hailing the customer, helping the customer or monitoring) in cooperation.

After notifying the electronic devices 32 that the customer in the specific state is present, if the specific state is solved, that is, the processor 41 discriminates that the specific state changes to a normal state during shopping (No in Act 5), the processor 41 discriminates that the notification is released (Yes in Act 10).

For example, if the sensor 24 (the weight sensor) detects that the customer discriminated as being in the state of the “commodity search” takes a commodity from the commodity shelf 13, the processor 41 can discriminate that the specific state changes to the normal state during shopping.

If the customer (the child) who is likely to be a “stray child” is present near another customer to whom the same group ID is set, the processor 41 can discriminate that the state in which the customer (the child) is likely to be a “stray child” is solved.

If the solution of the specific state is discriminated in this way, the processor 41 transmits, to the electronic devices 32, a release notification indicating that the customer attendance for the customer in the specific state becomes unnecessary. The processor 41 may transmit the release notification to the electronic device 32 carried by the store clerk in charge of customer attendance or may transmit the release notification to the electronic devices 32 of all the store clerks at the same time.

In this way, in the notification system in this embodiment, if it is discriminated that the customer is in the specific state, information corresponding to the specific state is transmitted to the plurality of electronic devices 32 respectively carried by the store clerks in the store 10. Accordingly, the plurality of store clerks can share the information concerning the customer in the specific state. Therefore, the store clerks can recognize, for example, where in the store 10 the customer is present, in what kind of state the customer is, and which store clerk attends the customer and can appropriately attend a customer who needs help or the like.

The processing explained in at least one embodiment can be provided to various apparatuses while being written in a recording medium such as a magnetic disk (a flexible disk, a hard disk, or the like), an optical disk (a CD-ROM, a DVD, or the like), or a semiconductor memory as a program that can be executed by a computer. The processing can also be transmitted by a communication medium and provided to the various apparatuses. The computer reads the program recorded in the recording medium or receives the program via the communication medium and is controlled to operate by the program to thereby execute the processing explained above.

Several embodiments are explained above. However, the embodiments are presented as examples and are not intended to limit the scope of the invention. The various embodiments can be implemented in other various forms. Various omissions, substitutions, and changes can be made without departing from the spirit of the embodiments. These embodiments and modifications of the embodiments are included in the scope and the gist of the disclosure and included in the inventions described in claims and the scope of equivalents of the inventions.

What is claimed is:

1. A notification system comprising:
at least one computer configured to:
discriminate a state of a customer in a store; and
when a specific state by the customer is discriminated, transmit first information corresponding to the specific state to a plurality of electronic devices respectively carried by store clerks in the store.

2. The system according to claim 1, wherein the at least one computer is further configured to:
receive, from the electronic devices, responses to the transmission of the first information; and
transmit, to at least one of the electronic devices, second information corresponding to the received responses.

3. The system according to claim 2, wherein the at least one computer is further configured to, when it has been discriminated that the specific state of the customer has been solved, transmit a release message indicating the specific state of the customer has been solved to at least one of the electronic devices.

4. The system according to claim 1, wherein the at least one computer is further configured to transmit the first information including position information indicating a position in the store of a customer in a specific state and attribute information corresponding to the specific state.

5. The system according to claim 4, wherein the at least one computer is further configured to discriminate the state of the customer based in part on the position information.

6. The system according to claim 2, wherein the at least one computer is further configured to transmit second information including information indicating an emergency degree corresponding to the specific state by the customer and a number of store clerks attending the customer.

7. The system according to claim 1, further comprising a monitoring system configured to monitor customer action.

8. The system according to claim 7, wherein the monitoring system includes at least one camera or sensor arranged to monitor the customer.

9. The system according to claim 8, wherein the at least one camera or sensor includes one or more weight sensors, infrared sensors or microphones.

10. The system according to claim 1, wherein the specific state is one of a commodity search by the customer, a stray child, or an abnormal action by the customer.

11. A computer implemented notification method comprising:
discriminating a state of a customer in a store; and
when a specific state by the customer is discriminated, transmitting information corresponding to the specific state to a plurality of electronic devices respectively carried by store clerks in the store.

12. The method according to claim 11, further comprising:
receiving, from the electronic devices, responses to the transmission of the first information; and
transmitting second information corresponding to the response to at least one of the electronic devices.

13. The method according to claim 12, wherein, when it has been discriminated that the specific state of the customer has been solved, transmitting a release message indicating that the specific state of the customer has been solved to at least one of the electronic devices.

14. The method according to claim 11, further comprising transmitting the first information including position information indicating a position in the store of a customer in a specific state and attribute information corresponding to the specific state.

15. The method according to claim 14, wherein discriminating the state of the customer is based in part on the position information.

16. The method according to claim 12, wherein the second information includes information indicating an emergency degree corresponding to the specific state by the customer and a number of store clerks who attend the customer.

17. The method according to claim 11, wherein the specific state is one of a commodity search by the customer, a stray child, or an abnormal action by the customer.
